(19) United States
(12) Patent Application Publication
(10) Pub. No.: US 2011/0060854 A1
(43) Pub. Date: Mar. 10, 2011

(54) FUNCTIONAL CONFIGURATION WIZARD

(76) Inventor: NEERAJ MANOCHA, Nabha (IN)

(21) Appl. No.: 12/554,985

(22) Filed: Sep. 8, 2009

(51) Int. Cl. G06F 13/00; G06F 3/00

(52) U.S. Cl. 710/104; 715/762

(57) ABSTRACT

Described herein are methods and systems for configuration of complex applications. The configuration is performed by invoking from a repository of an executable checklist. The repository includes executable checklists to be used for different configuration scenarios. An executable checklist consists of all the necessary activities for a particular configuration setting.

### FIELD OF THE INVENTION

The invention relates to configuration of computer programs. More precisely, the invention relates to configuration of complex multi component applications.

### BACKGROUND OF THE INVENTION

Driven by the insatiable demand for features and performance, computer programs have evolved to include complex applications that require multiple configuration settings. For example, business software and enterprise applications typically are complex software systems that consist of multiple interrelated modules each with its own specialized functionality. Such systems typically require a complex configuration. A number of tools and features exist for facilitating the configuration of complex systems. Complex systems are prone to erroneous configuration due to the complex relationships and dependencies between all their modules. Proper functionality of one module may require proper configurations settings of several other related modules.

### SUMMARY OF THE INVENTION

A computerized method and system for configuration setting are described. In one embodiment of the invention, the method includes receiving a selection for a configuration scenario from a repository and displaying an executable checklist of configuration activities according to the selected scenario. The method also includes receiving a user action for execution of a configuration activity and receiving a user input that indicates some update of the status of the executed configuration activity and storing the current status of the activity.

In another embodiment of the invention, the system includes a memory with a configuration module to retrieve from a repository the needed configuration activities, according to a user selected scenario, and directing the user to configure the retrieved configuration activities. The system also includes a processor to execute the instructions in the memory with the configuration module and a display to render a GUI to represent the output from the execution of the configuration module.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram with an exemplary illustration of a list of different configuration settings for a complex application.

FIG. 2 is a block diagram with an exemplary illustration of a list of different configuration settings for a complex application.

FIG. 3 is a block diagram with an exemplary illustration of an error message due to missing configuration.

FIG. 4 is a block diagram with an exemplary illustration of an error message due to missing configuration.

FIG. 5 is a block diagram with an exemplary illustration of a list of configuration activities for setting a particular functionality in a complex application.

FIG. 6 is a flow diagram of an embodiment of a method for implementing configuration settings needed for proper operation of related software modules.

FIG. 7 is a block diagram of an embodiment of a computer system for configuration setting.

### DETAILED DESCRIPTION

Described herein are methods and systems for configuration of complex applications by invoking an executable checklist of all the necessary activities for a particular configuration setting.

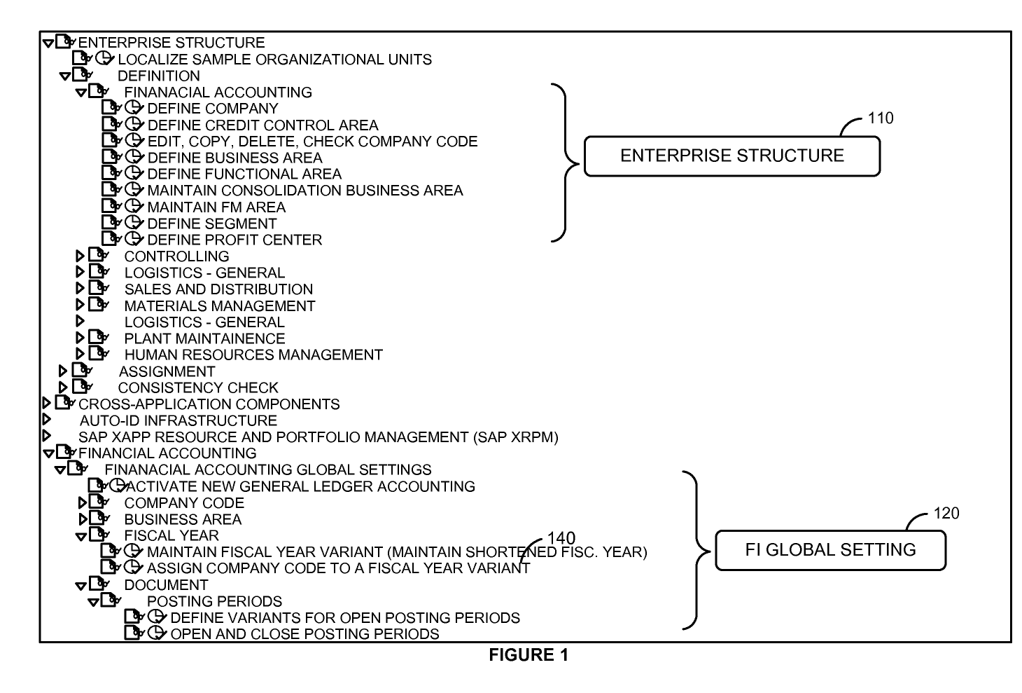

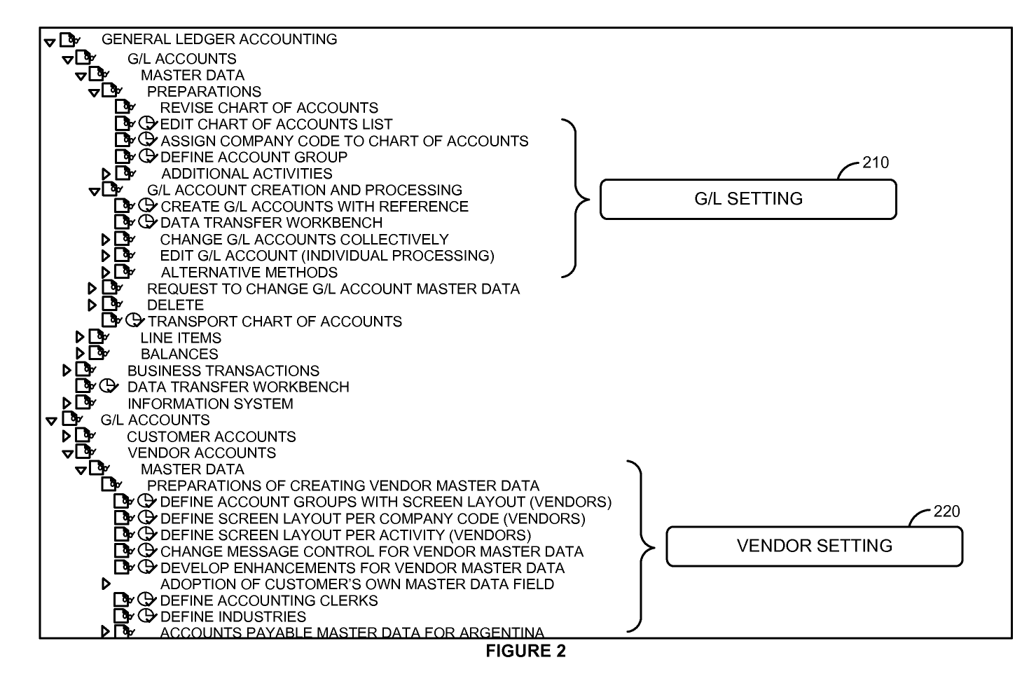

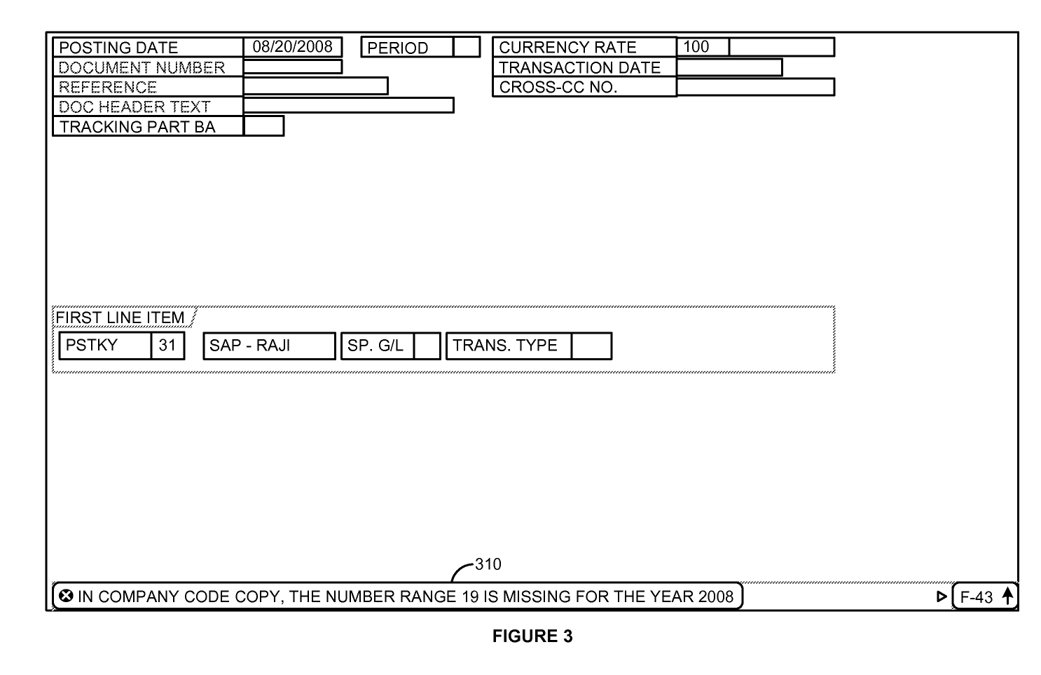

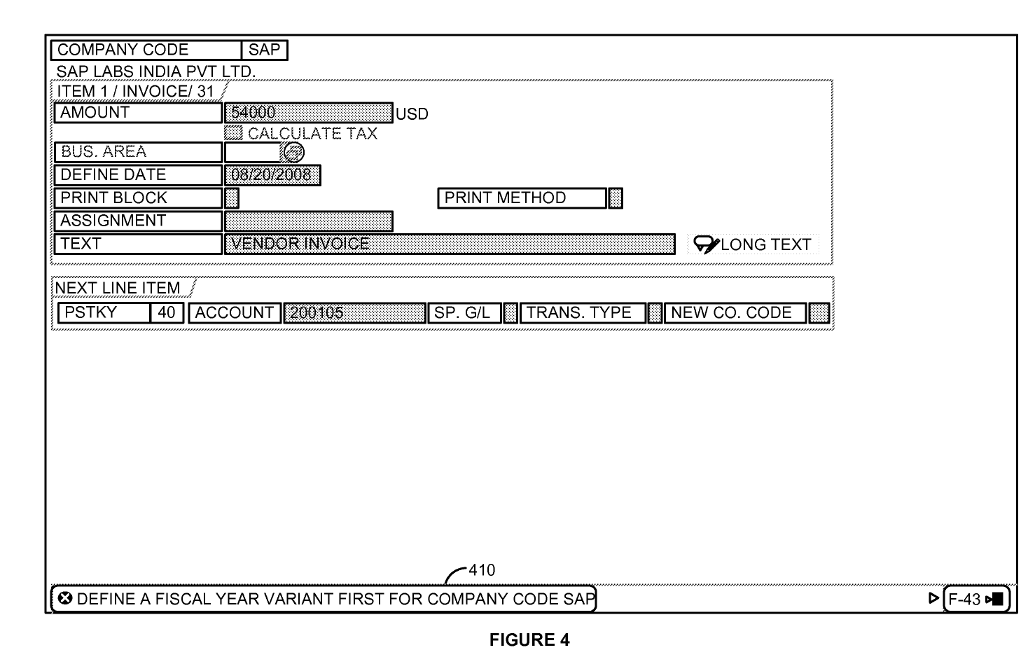

Multiple configuration settings may need to be defined and assigned in order to successfully perform an activity that is part of a complex business application. For example, to perform a successful FI (Financial Accounting) activity in a SAP system, the enterprise structure setting, FI global setting, G/L accounting setting, vendor configuration setting, and customer configuration setting are some of the settings that may need to be configured. FIGS. 1 and 2 represent exemplary illustration of some of these different configuration settings, as presented in the SAP Implementation Guide (IMG). For instance, the enterprise structure setting 110, FI global setting 120, G/L accounting setting 210, and vendor configuration setting 220 do not appear in consecutive order and as such may be located in different navigation paths in the IMG. Moreover, there may not be any logical connections between some of these modules or a user might not be aware of such connections, so missing a configuration or an assignment is very likely. Such errors in missing configuration may result in further inconsistencies. FIGS. 3 and 4 illustrate such exemplary problems due to missing configurations. In FIG. 3, the error message 310 may appear, if “Vendor Document Number Range” is not configured. Similarly, in FIG. 4, the error 410 is shown, if “Assignment of Fiscal Year Variant to Company code” 140, as presented in FIG. 1, is not configured.

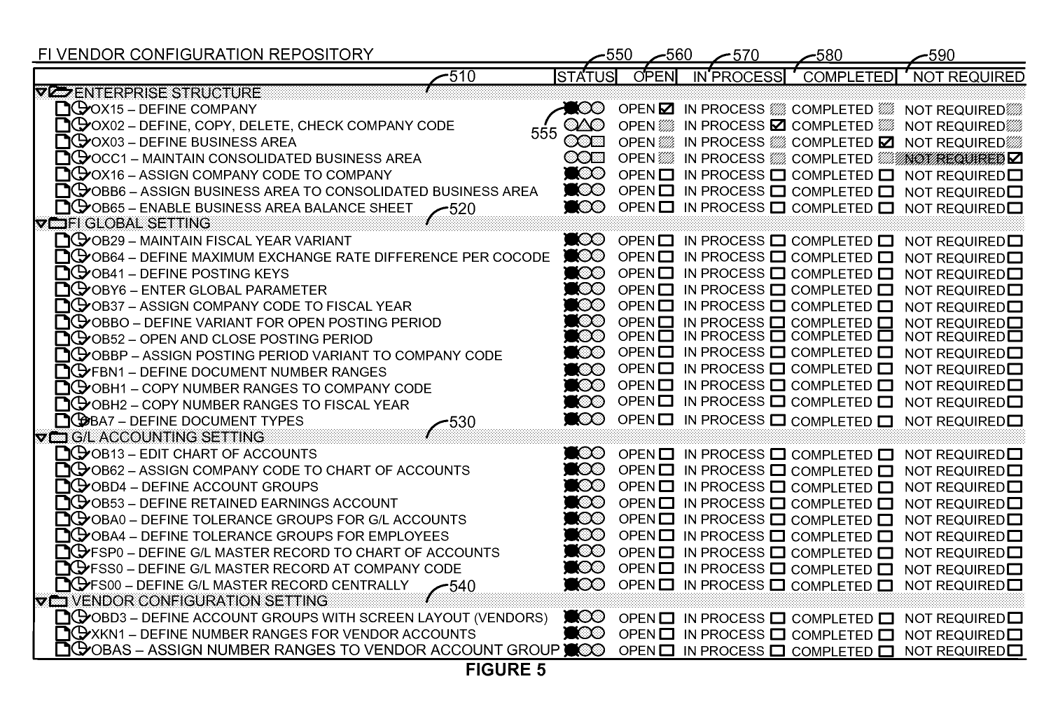

According to one embodiment, the issues as explained with reference to FIGS. 1, 2, 3, and 4 may be overcome by having a repository with an executable checklist of the configuration activities necessary for completing a proper configuration setting. An executable checklist is an application from where all the configuration activities can be executed. FIG. 5 represents an exemplary illustration of such an executable checklist including all the necessary configuration activities for configuring a particular functionality in a complex application. The configuration activities in this example are part of four different settings: enterprise structure 510, FI global setting 520, G/L accounting setting 530, and vendor configuration setting 540. An additional “STATUS” field 550 may be used to show the state of the configuration activities. In one embodiment, the status, as shown in FIG. 5, may comprise “Open” 560, “In process” 570, “Completed” 580, and “Not required” 590 fields. In another embodiment there might be a colorful or shaped indication of the status to easily visualize the state of the activities. In one embodiment, as in FIG. 5, this indication is done by highlights (or other aids for drawing attention to the screen) and geometric figures 555 that are associated with various statuses.

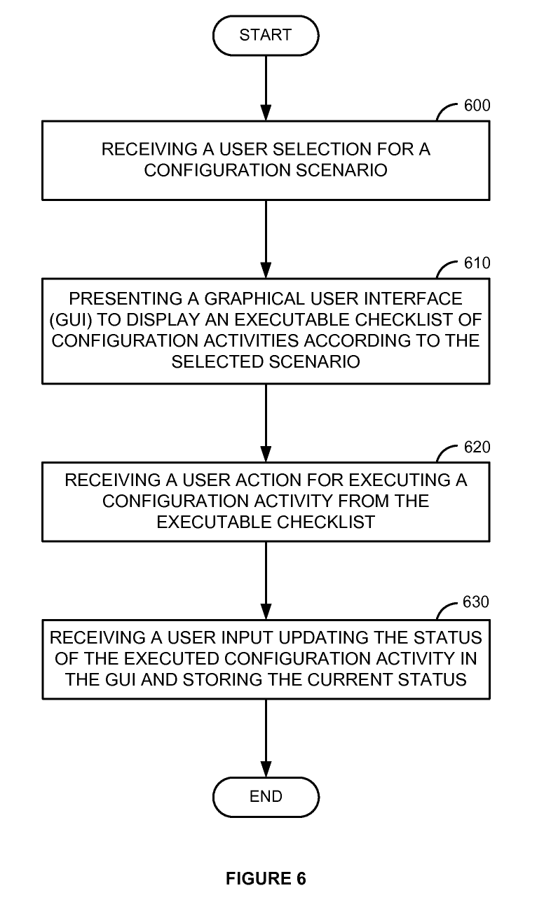

FIG. 6 is a flow diagram of an embodiment of a method for implementing configuration settings needed for proper operation of related software modules. At block 600, a configuration scenario is selected by receiving a user action. This scenario includes the exact configuration activities that should be performed for proper configuration of a particular functionality. The different instances of scenario that are related to the possible configurable functionalities are housed in a repository. This repository may reside either at an internal or external database. At block 610, an executable checklist of the configuration activities invoked at block 600 are displayed in a Graphical User Interface (GUI). At block 620, a user action is received for executing a configuration activity from the executable checklist. This user action may be, for example, a menu item selection or a mouse click. Thus the user is directed to perform the configuration, which is intrinsic to the executed activity from the checklist. The executable checklist serves as a shortcut to lead the user to the place for configuration of the different activities listed. At block 630, a user input is received that indicates some update in the status of one or more of the listed configuration activities in the GUI. For example, the user may be prompted to change the status of an executed activity, before directing the user back to the checklist. In one embodiment, a tick may be selected according to the state of the activity. As shown in FIG. 5, the state of the activity may be “Open” 560, “In process” 570, “Completed” 580, or “Not required” 590 and the user input may be a tick next to one of these status fields. In another embodiment, an indicator with different color may be used for the different states of the configuration activities. There might also be a combination of both color and shape for the purpose of distinguishing the state of the configuration activities. The updated status of the configuration activities is saved, thus providing the opportunity for accomplishing the configuration setting of the functionality at stages and not obligatory at once in one session.

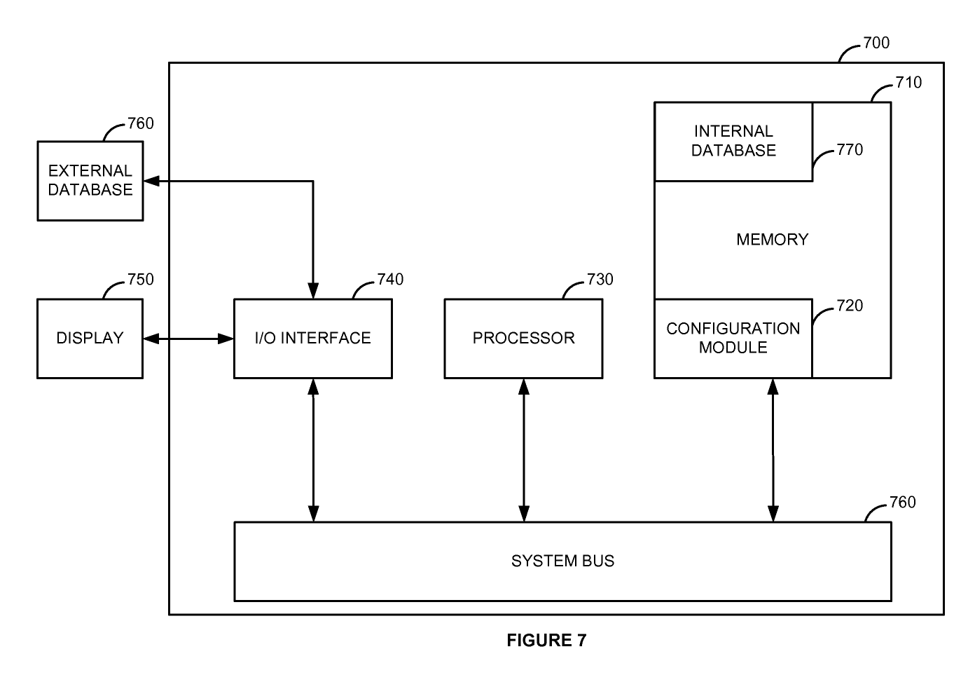

FIG. 7 is a block diagram of an embodiment of the invention for a computer system 700 for configuration setting. The computer system 700 incorporates a memory 710, a processor 730 and an I/O interface 740. The memory 710, the processor 730 and the I/O interface 740 may communicate with each other via the system bus 760. The memory 710 encompasses an internal database 770 and a configuration module 720. A display 750 is connected to the system 700 via the I/O interface 740. The configuration module 720 is used in configuring complex applications. After receiving a selection of a concrete configuration scenario, the configuration module 720 is responsible for retrieving an executable checklist of the configuration activities according to the selected scenario from a repository. The repository may be internal or eternal to the computer system 700. An internal repository might be an internal database 770 residing at the memory 710 or an external database 780 connected to the computer system 700 by means of the I/O interface 740. The executable checklist is represented in a GUI, rendered on the display 850. The configuration module 720 is also operable to direct the user for configuring the activities that had been executed from the executable checklist by opening an application or module from where the configuration should be performed.

An embodiment of the present invention relates to a computer storage product with a computer-readable medium having computer code thereon for performing various computer-implemented operations. The media and computer code may be those specially designed and constructed for the purposes of the present invention, or they may of the kind well known and available to those having skill in the computer software arts. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine executable software instructions.

The foregoing description, for purposes of explanation, used specific nomenclature to provide a thorough understanding of the invention. However, it will be apparent to one skilled in the art, that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and the equivalents define the scope of the invention.

What is claimed is:

1. A computer readable medium comprising machine readable instructions, which, when executed by a machine, causes the machine to perform a method, comprising:
receiving a user selection for a configuration scenario from a repository;
presenting a Graphical User Interface (GUI) to display an executable checklist of configuration activities according to the selected configuration scenario;
receiving a user action for executing a configuration activity from the executable checklist; and
receiving a user input updating the status of the executed configuration activity in the GUI and storing the current status in a status field.

2. The computer readable medium of claim 1, wherein the repository resides at one of an internal or an external database.

3. The computer readable medium of claim 1, wherein the user action for executing a configuration activity is one of a mouse click or a menu item selection.

4. The computer readable medium of claim 1, wherein the status field comprises one or more of “In process”, “Open”, “Completed”, and “Not required” fields.

5. The computer readable medium of claim 1, wherein the status field comprises one or more of a colored or shaped indicator for the state of the configuration activities.

6. A computerized method for configuration setting, comprising:
receiving a user selection for a configuration scenario from a repository;
presenting a Graphical User Interface (GUI) to display an executable checklist of configuration activities according to the selected configuration scenario;
receiving a user action for executing a configuration activity from the executable checklist; and
receiving a user input updating the status of the executed configuration activity in the GUI and storing the current status in a status field.

7. The method of claim 6, wherein the repository resides at one of an internal or an external database.

8. The method of claim 6, wherein the user action for executing a configuration activity is one of a mouse click or a menu item selection.

9. The method of claim 6, wherein the status field comprises one or more of “In process”, “Open”, “Completed”, and “Not required” fields.

10. The method of claim 6, wherein the status field comprises one or more of a colored or shaped indicator for the state of the configuration activities.

11. A computer system for configuration setting, comprising:
a memory, the memory having stored thereon executable instructions related to a configuration module operable to retrieve from a repository the needed configuration activities, according to a user selected scenario, and directing the user to configure the retrieved configuration activities;
a processor operable to execute the instructions in the memory with the configuration module; and
a display to render an output of the execution of the configuration module.

12. The computer system of claim 11, wherein the repository resides at one of an internal or external database.

13. The computer system of claim 11, wherein the configuration module is further operable to keep track of status of the retrieved configuration activities.
